(19) United States
(12) Patent Application Publication
(10) Pub. No.: US 2013/0101290 A1
(43) Pub. Date: Apr. 25, 2013

(54) METHOD AND APPARATUS TO OVERCOME LINEWIDTH PROBLEMS IN FAST RECONFIGURABLE NETWORKS

(71) Applicants: Prince Anandarajah, Dublin (IE); Liam Barry, Dublin (IE); Philip Perry, Dublin (IE); Kai Shi, Dublin (IE); Frank Smyth, Dublin (IE)

(72) Inventors: Prince Anandarajah, Dublin (IE); Liam Barry, Dublin (IE); Philip Perry, Dublin (IE); Kai Shi, Dublin (IE); Frank Smyth, Dublin (IE)

(73) Assignee: DUBLIN CITY UNIVERSITY, Dublin (IE)

(21) Appl. No.: 13/642,261

(22) PCT Filed: Apr. 12, 2011
(86) PCT No.: PCT/EP2011/055696

§ 371 Date: Jan. 7, 2013

(30) Foreign Application Priority Data
Apr. 21, 2010 (GB) 1006674.4

(51) Int. Cl. H04J 14/02

(52) U.S. Cl. CPC H04J 14/02
USPC 398/49; 398/48

(57) ABSTRACT

In wavelength switching optical networks, the optical data being transmitted may be routed to different end points by switching the operating frequency of the laser. However, the phase noise of the laser source increases following a switching event. This increased phase noise can prevent the successful transmission of phase modulation formats which are sensitive to it. Accordingly, it is generally necessary to wait a short period before transmitting data. However, the period may be as long as the data packet being transmitted (e.g. 3 μS), which is a limiting factor. The present application obviates this problem by including a radio frequency pilot tone with the data prior to modulation onto the optical carrier.

### FIELD OF THE APPLICATION

The present application relates to the communication of data by optical transmission.

### BACKGROUND

Optical transmission systems have traditionally differed substantially from RF transmission systems. While optical systems are typically unipolar, with information carried on the optical intensity and direct detection employed at the receiver, RF systems conversely are typically bipolar, with information carried on the electric field and coherent reception employed at the receiver.

Coherent optical communication was however, studied extensively in the 1980s because of the improved receiver sensitivity that it offered over direct detection systems. The invention of the erbium doped fiber amplifier (EDFA) in the late 1980s meant that superior receiver sensitivity was achievable using an optical amplifier as a low noise preamplifier with direct detection and hence research into the more complicated coherent detection techniques declined.

Recently, however, coherent optical communication has re-emerged for two main reasons: Firstly, the bandwidth offered by optical amplifiers is filling up, and hence higher order modulation formats offering improved spectral efficiency are required. Secondly, the convergence between the speed of digital signal processors and optical line rates has allowed the use of digital signal processing (DSP) techniques to overcome inherent optical impairments such as chromatic dispersion and polarization mode dispersion.

Nevertheless, full coherent reception in the optical domain remains a challenge. Optical phase locking between the source laser and receiver local oscillator laser is difficult to implement and the inherent phase noise of standard laser diodes means that they do not easily support higher order modulation formats. Low phase-noise lasers are typically expensive and bulky, and are not widely deployed today. An all-digital approach to the phase locking problem has been proposed—H. Sun et al, “Real time measurements of a 40 Gb/s coherent system,” Optics Express, vol. 16, pp. 873-879, 2008. However, such techniques are relatively costly and consume significant power.

In wavelength switching optical networks, the optical data being transmitted may be routed to different end points by switching the operating frequency of the laser. However, the phase noise of the laser source increases following a switching event.—Mishra, A. K.; Ellis, A. D.; Barry, L. P.; Farrell, T.; “Time-resolved linewidth measurements of a wavelength switched SG-DBR laser for optical packet switched networks,” Optical Fiber communication/National Fiber Optic Engineers Conference, 2008. OFC/NFOEC 2008. Conference on, vol., no., pp. 1-3, 24-28 Feb. 2008. This increased phase noise can prevent the successful transmission of phase modulation formats which are sensitive to it. Accordingly, it is generally necessary to wait a short period before transmitting data. However, the period may be as long as the data packet being transmitted (e.g. 3 μS), which is a limiting factor. The present application seeks to address this problem in reconfigurable networks.

### SUMMARY

By coupling an RF tone with the electrical data prior to optical modulation of an optical signal, the present application provides for cancellation of phase noise that arises in a reconfigurable transmission system during switching of the frequency of the tunable laser. An advantage of this is that phase noise arising from the frequency switching in the tunable laser providing the optical signal may be significantly obviated at the receiver. With this approach network throughput is greatly increased as the requirement of a delay for phase noise settling is removed. Accordingly, the present application provides an optical transmission system, a reconfigurable optical network and an optical receiver in accordance with the claims which follow.

In one aspect an optical transmission system is provided for the transmission of a data signal in a reconfigurable optical network. The system comprises a tunable laser for producing an optical signal, a switching circuit for switching the operating frequency of the tunable laser for a reconfiguration in the optical network, an electrical oscillator or synthesised source for producing a tone, a combining circuit for additively coupling the tone with the data signal to provide a combined tone-data signal and a modulator for modulating the optical signal with the tone-data signal for onward transmission.

The tone-data signal may be used to directly modulate the laser via a bias circuit or the modulator may be an optical modulator for modulating the optical signal with the combined tone-data signal. In the case of an optical modulation, the optical modulator may employ quadrature phase modulation and the data signal is provided as two separate data signals (I,Q) and wherein the tone is combined with each of the separate data signals. The system produces a double sideband optical signal with each sideband containing the tone. The system may further comprise an optical filter for the removal of one of the sidebands so as to create a single sideband optical signal.

The tone may be a higher frequency to that of the data signal. The optical transmission system may be used to provide a reconfigurable optical network with the addition of an optical router for routing the transmitted optical signal. In which case, the optical router may be an arrayed waveguide grating router.

A corresponding optical receiver may be provided for receiving a data signal generated by the optical transmission system which has been optically modulated with a tone onto an optical signal. Such a receiver might include a photodetector for converting the modulated optical signal into electrical, a filter for filtering the electrical signal which is configured to allow the tone to pass through whilst attenuating baseband signals, an electrical local oscillator for producing a local tone, and a mixing circuit for mixing the local tone with the filtered signal to demodulate the data signal from the tone.

Such an optical receiver in circumstances where the optical signal was modulated using quadrature modulation, the mixing circuit may be configured to decompose the data signal into two separate complex valued (I,Q) signals. The optical receiver may further comprise digital sampling circuitry for sampling the separate complex valued signals. The optical receiver may comprise a circuit for demodulating the sampled separate complex valued signals to recover one or more data streams.

In these systems a tunable laser may be used to generate a tunable comb of optical signals, where each of these optical signals may be modulated independently and routed independently through a wavelength selective network.

In one variation, the modulation scheme applied to the systems may be switched according to the condition of the channel between the transmitter and the receiver.

In another aspect, a method is provided for the optical transmission of a data signal in a reconfigurable optical network, the method comprising the steps of coupling a tone with the data signal to provide a combined tone-data signal and modulating the optical signal with the tone-data signal for onward transmission.

The method may employ direct modulation of the laser by applying the tone-data signal as a bias to the laser. Alternatively, optical modulation may be employed to modulate the optical signal with the combined tone-data signal. The modulation technique employed may be quadrature phase modulation where the data signal is provided as two separate data signals (I,Q). In this arrangement, the tone is combined separately with each of the separate data signals.

In one arrangement, the method results in the production of a double sideband optical signal with each sideband containing the tone and in which case, the method may further comprise optically filtering to remove of one of the sidebands so as to create a single sideband optical signal.

The tone may be a higher frequency to that of the data signal. An optical router may be employed for routing the transmitted optical signal, for example an arrayed waveguide grating router.

The method extends to the receiving of a data signal generated by one of the aforementioned methods. The method of receiving suitably comprises the converting the modulated optical signal into an electrical signal, filtering the electrical signal where the filtering allows the tone to pass through whilst attenuating baseband signals and mixing a locally generated tone signal with the filtered signal to demodulate the data signal from the tone. Where the optical signal was modulated using quadrature modulation the mixing step decomposes the data signal into two separate complex valued (I,Q) signals. A further step of digitally sampling the separate complex valued signals may be provided to place the data in the digital domain. Moreover the sampled separate complex valued signals may be demodulated to recover one or more data streams.

These and other aspects of the present invention will be understood and become apparent from the description which follows.

### DESCRIPTION OF DRAWINGS

The present application will now be described with reference to the accompanying drawings in which:

FIG. 1 is a schematic drawing of a optical burst/packet transmitter to which the present application may be directed,

FIG. 2 is a schematic drawing showing a modified and more detailed form of FIG. 1 encompassing an exemplary arrangement of the present application,

FIG. 3 is an experimental configuration employed to test the arrangement of FIG. 2,

FIG. 4 illustrates results from the experimental configuration of FIG. 3,

FIG. 5 illustrates further results from the experimental configuration of FIG. 3, and

FIG. 6 illustrates yet further results from the experimental configuration of FIG. 3.

### DETAILED DESCRIPTION

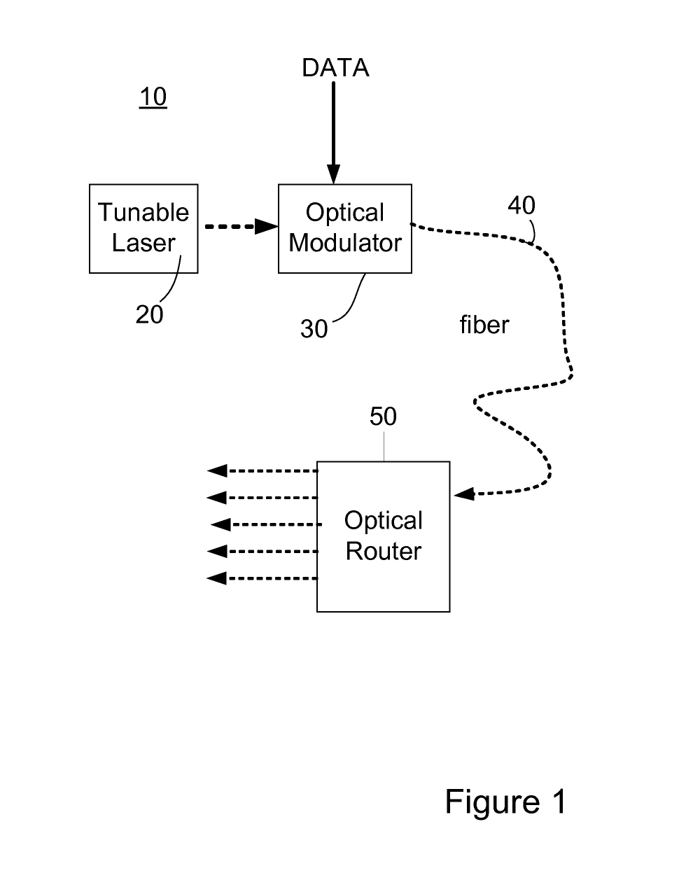

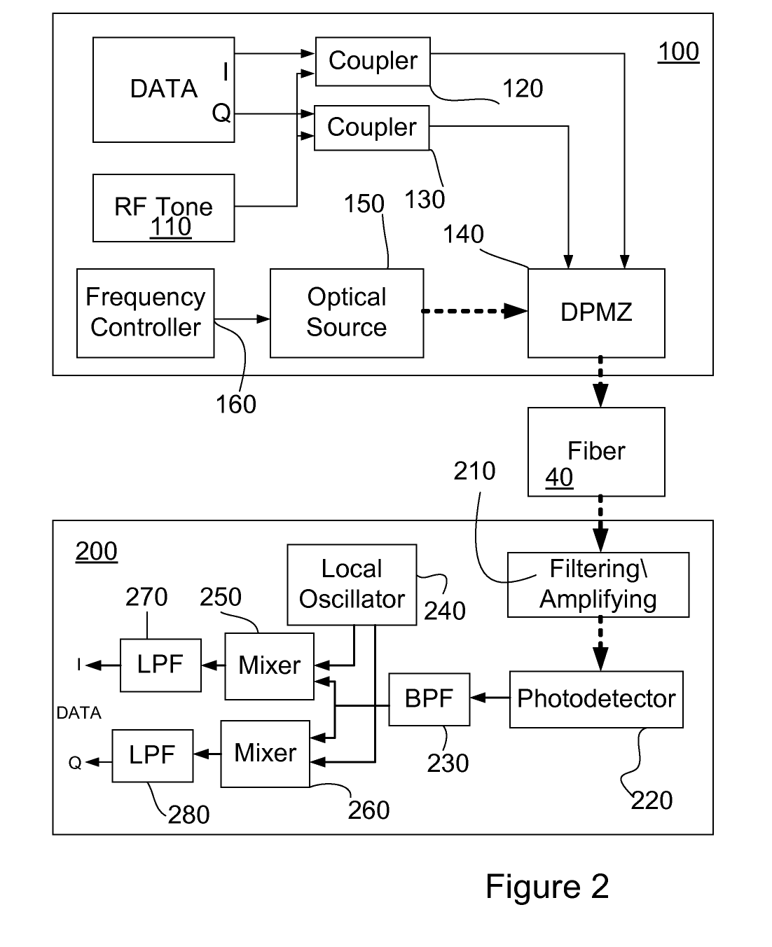

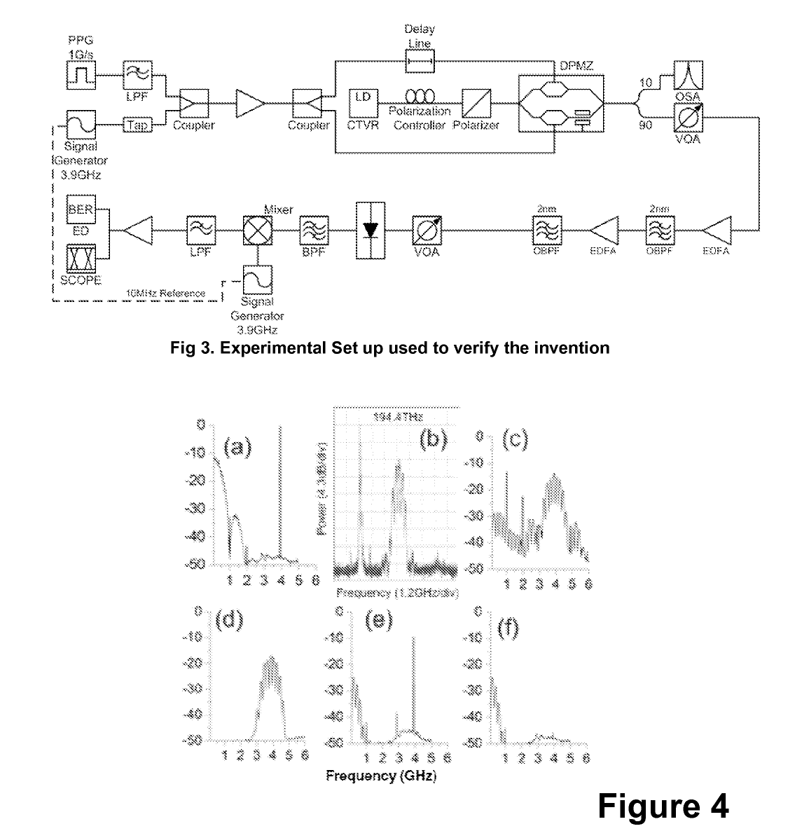

The application will now be described with reference to the known arrangement 10 of FIG. 1, which provides an optical phase modulated transmitter. More specifically, the arrangement of FIG. 2 and the experimental setup of FIG. 3 provides for quadrature phase shift keying (QPSK) modulation, which would be familiar to those skilled in the art although the techniques of the present application are not limited to this method of phase modulation and may equally be applied to other phase modulation techniques including for example but not limited to n-Quadrature amplitude modulation (QAM), Orthogonal frequency-division multiplexing (OFDM).

A tunable laser 20, of a type as would be familiar to those skilled in the art, is provided whose frequency may be switched as required. Once operating at a particular frequency the light from the laser may be modulated with a data signal using an optical IQ modulator 30 such as a nested Mach-Zehnder modulator. The modulated light may then be transmitted through an optical waveguide 40, conventionally an optical fibre. The advantage of this that en-route, the transmitted light may passed through an optical router 50 such as an arrayed waveguide grating router (AWGR), where the data may be directed to a particular output from several available outputs based on the frequency of the transmitted light. In this way, data may be routed by changing the frequency of the transmitting laser. This approach is faster and more efficient than conventional electronic routers which necessitate the demodulation of the data signal from the optical domain into the electrical domain and the reconversion into the optical domain for onward transmission.

As a laser switches between wavelengths in order to route the data through the network the phase noise (represented by the linewidth) increases greatly in the period following the switch preventing the successful transmission of advanced optical modulation formats. Conventionally therefore there is a general requirement to delay data transmission, for approximately 3 μSec—Mishra, A. K.; Ellis, A. D.; Barry, L. P.; Farrell, T.; “Time-resolved linewidth measurements of a wavelength switched SG-DBR laser for optical packet switched networks,” Optical Fiber communication/National Fiber Optic Engineers Conference, 2008. OFC/NFOEC 2008. Conference on, vol., no., pp. 1-3, 24-28 Feb. 2008, whilst the frequency of the laser settles within a required margin (for example ±2.5% of the channel bandwidth) and phase noise of the laser settles to a value that will support the particular modulation format being employed.

The arrangement 100 of FIG. 2 incorporates the use of a pilot tone to substantially obviate this limitation. More specifically, the present application couples an RF tone together with the baseband data in the electrical domain. It should be noted that coupling in the context of this application is additive, e.g. both electrical signals are applied to the same conductor. There is no modulative interaction between the electrical signals of the RF tone and the data as would occur in a electrical mixer or modulator. Alternatively stated, the RF tone is not modulated by the data or vice versa in the electrical domain. After conversion to an optical signal and transmission over an optical waveguide such as fiber the tone and complex data mix together in the optical detector of the receiver. This results in an upconverted copy of the complex data centred on the RF tone. This RF signal is then bandpass filtered to remove the residual amplitude modulation of the baseband signal before IQ demodulation is carried out using an RF local oscillator (LO) at the tone frequency. The phase noise tolerance of the architecture is based on the fact that the RF tone and the data modulate the same optical carrier and they are therefore optically coherent. When they beat together in the photodetector any phase noise from the optical source is cancelled as long as the coherence condition remains. The dominant source of phase noise will then be the electrical sources, which typically tend to exhibit a phase noise that is orders of magnitude lower than that of an optical source.

The arrangement of FIG. 2 will now be described in greater detail with the solid lines representing electrical paths and the dashed lines representing optical paths. More specifically the arrangement of FIG. 2 will be described with reference to an optical transmitter 100 and an optical receiver 200. The optical transmitter 100 provides two quadrature data signals I and Q using techniques that would be familiar to those skilled in the art. A local oscillator 110 generates a pilot tone which is coupled by means of a coupler 120, 130 to each of the I and Q data signals. The resulting coupled data and pilot signals are then provided to an optical modulator, suitable a dual parallel Mach-Zehnder (DPMZ) modulator 140, to modulate the data (I and Q) with pilot tones onto an optical carrier. The optical carrier in turn is provided by a tunable laser 150. Examples of tunable lasers would include Distributed Bragg Reflector (DBR), External Cavity Lasers, Tunable vertical-cavity surface-emitting lasers (VCSEL) and distributed feedback (DFB) arrays. A frequency selector circuit 160 may be employed to adjust the operating frequency of the laser as required for routing of the optical signals or other purposes.

The optical signal may then be transmitted down fiber 40 as before and routed, by means of an optical router (not shown) as previously described, to an optical receiver.

At the receiver, the received optical signal may be amplified and\or filtered by one or more optical filters\amplifiers 210 as would conventionally be employed in the art. After optical filtering\amplification, the optical signal is provided to a photodetector 220 where it is converted into an electrical signal. In the conversion process, the RF pilot tone mixes with the modulated baseband data resulting in an upconverted copy of the baseband data at the RF tone frequency.

As the RF tone and the data were both transmitted on the same optical carrier, the phase noise on each is identical and cancellation of the phase noise occurs during the mixing process.

An electrical band pass filter 230 placed after the photodetector may be employed to extract the upconverted data. The filtered signal may then be mixed with a signal generated by a local oscillator 240 generating a local version of the RF pilot tone to demodulate the filtered signal and thus extract the data signal. It will be appreciated that a locking circuit as would be familiar to those skilled in the art may be employed to ensure that the receiver generated RF pilot tone matches that of the received pilot tone.

Where a quadrature modulation format is employed, both in-phase and quadrature-phase local oscillator signals are generated and mixed in respective mixing circuits 250, 260 with the upconverted data to demodulate the I and Q into separate analogue signals, where they may be passed through through appropriate low pass filters 270, 280 before digital sampling circuitry (not shown) may be employed to convert these analogue signals into digital equivalents. Once digitised, digital signal processing circuit(s) may be employed to recover one or more data streams.

For the purposes of additional explanation, the method will now be explained using equations representing the signals at various points and and commencing after the modulator, wherein the optical electric field may be expressed as:

$$E ( t ) = sin ( I ( t ) + sin ( {ω}_{p} t ) ) exp ( iω t ) + sin ( Q ( t ) + cos ( {ω}_{p} t ) ) exp ( iω t + i \frac{π}{2} ) \qquad Equation 1$$

where I(t) and Q(t) are baseband data signals and ωₚ and ω are the angular frequencies of the RF tone and optical carrier respectively. As the frequency of the data is typically a lot less than that of the optical carrier, equation 1 may be approximated as:

$$E ( t ) = ( I ( t ) + sin ( {ω}_{p} t ) ) exp ( iω t ) + ( Q ( t ) + cos ( {ω}_{p} t ) ) exp ( iω t + i \frac{π}{2} ) \qquad Equation 2$$

At the receiver, the square law photodiode results in the data signal and the RF tone being mixed together. The optical intensity S(t) can then be expressed as:

S(t)=(I(t)+sin(ωₚt))²+(Q(t)+cos(ωₚt))²

S(t)=I(t)²+Q(t)²+sin²(ωₚt)+cos²(ωₚt)+2I(t)sin(ωₚt)+2Q(t)cos(ωₚt)

In this expression the first four terms contribute to components at baseband and at twice the pilot tone frequency. The last two terms are the RF IQ data signal centred at ωₚ. It will be appreciated that bandpass filtration of the RF signal followed by IQ demodulation with an electrical Local oscillator O at ωₚ allows the data to be reliably recovered.

In order to demonstrate the effectiveness of the above method at cancelling the phase noise, experiments were conducted by the inventors on a static optical channel for convenience. Nonetheless, the inventors believe that a similar improvement in phase noise will occur where a tunable laser is used. The experimental apparatus is shown in FIG. 3 while spectra taken at various points in the system are presented in FIG. 4. In the experimental apparatus, an optical carrier from a laser source was modulated using an optical IQ modulator. The complementary data outputs from an Anritsu pulse pattern generator (PPG) were used to represent I and Q respectively. A pseudo-random bit stream (PRBS) with a length of 2³¹-1 was used and a delay in one of the paths served to decorrelate the patterns (it will be appreciated that such a delay is not required where the original I and Q data were not correlated). A low symbol rate of 1 Gbd was intentionally chosen to reduce the linewidth tolerance of the system. The data channels were each coupled with a 3.9 GHz RF tone and used to drive the modulator (it will be appreciated that the spectral efficiency may be improved by using a RF tone of frequency greater than or equal to twice the baud rate). The delay line also introduced a 90° phase shift in the tone applied to each arm causing suppression of the higher frequency RF tone. The resulting optical signal was a 1 Gbaud optical quadrature phase shift keyed (QPSK) signal with a single sideband tone separated from the optical carrier by 3.9 GHz. The optical spectrum of this signal is shown in FIG. 4(b). Measurements were taken with a back to back transmitter and receiver and also after transmission through 37.5 km of standard single mode fiber (SSMF).

The receiver consisted of a pair of erbium doped fiber amplifiers (EDFA) each followed by a 2 nm optical band pass filter, used to reduce the out of band amplified spontaneous emission (ASE) generated by the amplifiers. Following the amplifier pair was a 12.5 GHz photoreceiver (consisting of a positive-intrinsic-negative (PIN) photodetector and a transimpedence amplifier) whose input power was maintained at 0 dBm. The electrical spectrum at the output of the photoreceiver is shown in FIG. 4(c). The detected signal was bandpass filtered to reject the detected baseband data and harmonics (FIG. 4(d)), and then demodulated using an RF IQ mixer (FIG. 4(e)). A low-pass filter was used to reject the remaining RF signal and the LO (FIG. 4(f)) and a broadband data amplifier was used to boost the signal prior to the error detector and oscilloscope. The power entering the receiver was varied and the bit error rate (BER) as a function of received power was measured. In this proof of concept experiment the BER for I and Q were measured separately by varying the phase of the receiver LO by 90°. In the experimental set-up, it will be appreciated that a full phase locked loop was not required as the phase of the transmitter and receiver LOs were easily locked using their 10 MHz reference clocks. However, it will be appreciated that whilst the experimental set-up did not employ phase locking, the fact that this is performed in the electrical domain is significant and unlikely to significantly affect the data. Phase locking in the electrical domain represents a significant advantage performance wise over optical coherent receivers which require optical phase locking of a low linewidth optical LO to the optical source via an optical 90° hybrid and feedback circuit.

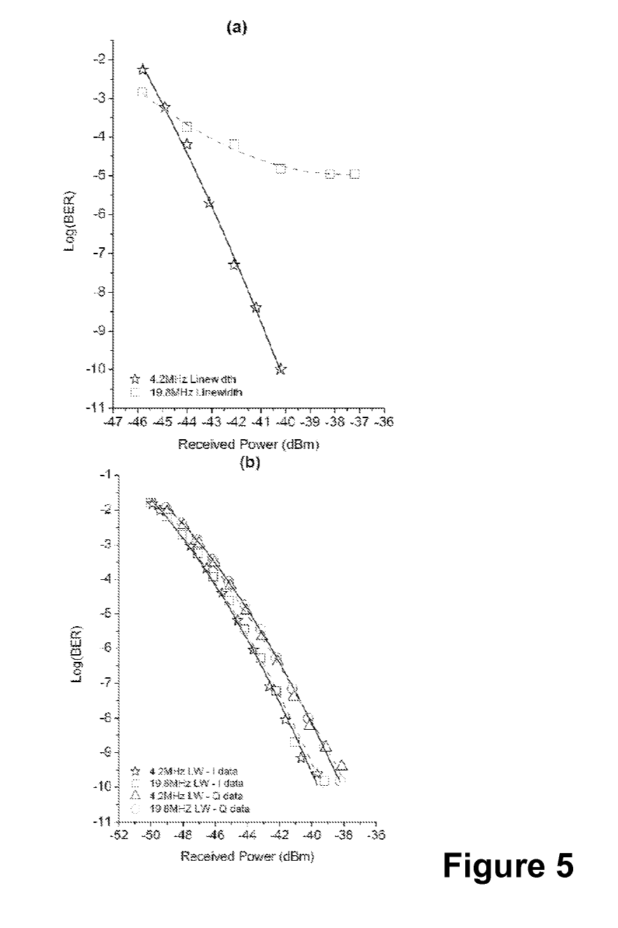

In FIG. 5(a) the BER versus received power of a standard 1.25 Gb/s optical DPSK system is shown for two different optical source linewidths. The linewidth of a laser is related to its phase noise and the effect that the phase noise has on the performance is clear, with an error floor occurring when the linewidth increases from 4.2 MHz to 19.8 MHz. This phase noise related degradation in performance represents a serious problem for future optical systems as they migrate towards more advanced modulation formats. Any increase in the order of modulation puts even more stringent bounds on the acceptable source linewidth. In addition, a move from differential phase shift keying formats to fully coherent phase shift keying formats further reduces the phase noise tolerance.

In contrast to this, FIG. 5(b) shows the BER versus received power of the 1 Gbaud QPSK data using the presently described technique. It can be seen that an identical change in linewidth using the present technique causes no performance degradation. Using standard methods, the increase in bits per symbol, and the move from differential to absolute phase shift keying would cause further performance degradation over the system measured in FIG. 5(a). However, the phase noise cancellation effect introduced by this architecture eliminates this penalty. The observed penalty of approximately 2 dB between the in-phase and quadrature data is caused by a lower electrical signal to noise ratio (SNR) of the quadrature data prior to modulation onto the optical carrier. Nonetheless, error free transmission was achieved for both I and Q.

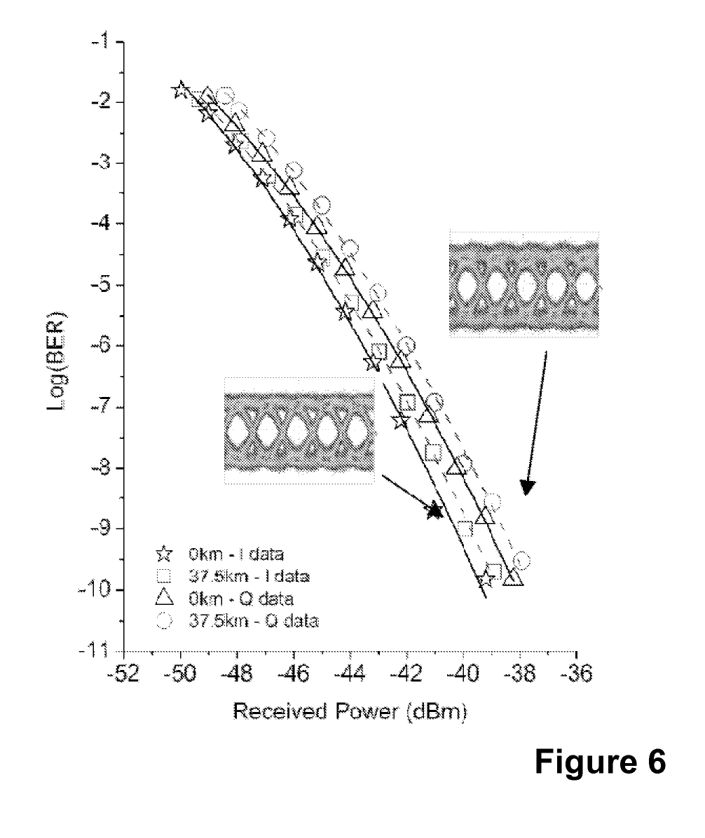

Transmission over 37.5 km of optical fiber has been successfully carried out to demonstrate the proposed architecture's suitability for the optical access network, where the use of low symbol rates allows high aggregate data rates while keeping costs low via the use of low bandwidth electronics. FIG. 6 shows that less than 1 dB of power penalty was observed between the back to-back and over-fiber cases. The insets show the eye diagrams of the I and Q data with a BER of 1×10⁻⁹.

As optical networks begin to employ coherent reception techniques the phase noise of the laser source and the optical local oscillator can cause seriously degrade the transmission performance. The systems and methods described herein enable the transmission of complex data formats and offer significantly improved linewidth tolerance over coherent optical systems. Whilst the transmitter architecture is a modified version of a conventional optical IQ transmitter, the receiver architecture is more typical of a coherent RF receiver employing an electrical LO and mixer. This provides high aggregate data rates using low bandwidth electronics, while eliminating the low phase noise requirement for the optical transmitter and completely removing the need for an optical local oscillator, optical 90° hybrid and optical phase locking at the receiver. The low cost nature of this solution makes it suitable for the optical access network.

More particularly, the teaching of the present application may readily be included in transceiver systems for photonic communications systems, which in turn may be employed in core, metro, access, local, networks, datacentres etc. One significant application is for fibre to the home, where the significant cost saving achieved by removing the need for an optical local oscillator in the receiver, and the possibility of squeezing greater numbers of customers on a single fiber due to the low bandwidth requirements of higher order coherent optical modulation formats make the teaching attractive as the need for local oscillators at each end point is obviated and switching between end customers may be achieved at the transmitter end with routing to each customer performed using optical routing, for example using an arrayed waveguide grating router (AWGR).

It will be appreciated that various improvements and modifications may be made. For example, the tunable laser may generate a comb of frequencies rather than a single frequency. In this arrangement, each of the optical signals in the comb may be modulated independently and routed independently through a wavelength selective network.

Similarly, the nature of the modulation scheme may be adapted depending on the condition of the channel to the receiver. This may be done to improve network efficiency or to accommodate nodes that have restricted modulation or demodulation capabilities. Also whilst the present application has been described with respect to separate optical modulation of the optical signal by the combined tone-data signal it will be appreciated that in some circumstances, the laser may be directly modulated. In which case the tone-data signal may be provided to the laser as a drive signal through a bias tee or similar circuit.

The words comprises/comprising when used in this specification are to specify the presence of stated features, integers, steps or components but does not preclude the presence or addition of one or more other features, integers, steps, components or groups thereof.

1. An optical transmission system for the transmission of a data signal in a reconfigurable optical network, the system comprising:
a) a tunable laser for producing an optical signal,
b) a switching circuit for switching the operating frequency of the tunable laser for a reconfiguration in the optical network,
c) an electrical oscillator or synthesised source for producing a tone,
d) a combining circuit for additively coupling the tone with the data signal to provide a combined tone-data signal and
e) a modulator for modulating the optical signal with the tone-data signal for onward transmission.

2. A system according to claim 1, wherein the tone-data signal is used to directly modulate the laser via a bias circuit.

3. A system according to claim 1, wherein the modulator is an optical modulator for modulating the optical signal with the combined tone-data signal.

4. A system according to claim 3, wherein the optical modulator employs quadrature phase modulation and the data signal is provided as two separate data signals (I,Q) and wherein the tone is combined with each of the separate data signals.

5. A system according to claim 1, wherein the system produces a double sideband optical signal with each sideband containing the tone and wherein the system further comprises an optical filter for the removal of one of the sidebands so as to create a single sideband optical signal.

6. A system according to claim 1, wherein the tone is a higher frequency to that of the data signal.

7. A reconfigurable optical network comprising the system of claim 1 and further comprising an optical router for routing the transmitted optical signal.

8. A reconfigurable optical network according to claim 7, wherein the optical router is an arrayed waveguide grating router.

9. An optical receiver for receiving a data signal generated according to claim 1 which has been optically modulated with a tone onto an optical signal, the receiver comprising:
a) a photodetector for converting the modulated optical signal into an electrical signal,
b) a filter for filtering the electrical signal which is configured to allow the tone to pass through whilst attenuating baseband signals,
c) an electrical local oscillator for producing a local tone,
d) a mixing circuit for mixing the local tone with the filtered signal to demodulate the data signal from the tone.

10. An optical receiver according to claim 9, wherein the optical signal was modulated using quadrature modulation and the mixing circuit is configured to decompose the data signal into two separate complex valued (I,Q) signals.

11. An optical receiver according to claim 10, further comprising digital sampling circuitry for sampling the separate complex valued signals.

12. An optical receiver according to claim 11, further comprising a circuit for demodulating the sampled separate complex valued signals to recover one or more data streams.

13. A system according to claim 11 whereby the tunable laser is used to generate a tunable comb of optical signals, where each of these optical signals may be modulated independently and routed independently through a wavelength selective network.

14. A system according to claim 1 where the modulation scheme applied to the system may be switched according to the condition of the channel between the transmitter and the receiver.

15. An optical data communication system
comprising a transmitter for the optical transmission of a data signal and a receiver for receiving the data signal, the transmitter comprising:
a tunable laser for producing an optical signal,
a switching circuit for switching the operating frequency of the tunable laser for a reconfiguration in the optical network,
an electrical oscillator or synthesised source for producing a tone,
a combining circuit for additively coupling the tone with the data signal to provide a combined tone-data signal
a modulator for modulating the optical signal with the tone-data signal for onward transmission; and
the receiver comprising:
a photodetector for converting the modulated optical signal into an electrical signal,
a filter for filtering the electrical signal which is configured to allow the tone to pass through whilst attenuating baseband signals,
an electrical local oscillator for producing a local tone, and
a mixing circuit for mixing the local tone with the filtered signal to demodulate the data signal from the tone.
